(19) United States
(12) Patent Application Publication
(10) Pub. No.: US 2005/0288948 A1
(43) Pub. Date: Dec. 29, 2005

(54) Systems, methods and computer readable media for measuring the performance and travel efficiency of a technician

(75) Inventors: Ravi Devulapalli, Alpharetta, GA (US); Thomas Duttera, Atlanta, GA (US); Jerome Timko, Lilburn, GA (US)

Correspondence Address: Merchant & Gould P.C., P.O. Box 2903, Minneapolis, MN, 55402-0903, US

(73) Assignee: BellSouth Intellectual Property Corporation

(21) Appl. No.: 10/987,233

(22) Filed: Nov. 12, 2004

Related U.S. Application Data
(60) Provisional application No. 60/582,229, filed on Jun. 23, 2004.

(51) Int. Cl. G06F 17/60

(52) U.S. Cl. 705/1; 705/10

(57) ABSTRACT

Systems, methods, and computer-readable media are for creating a technician performance measure for job-related travel and for measuring the efficiency of a technician. A planned travel time is calculated for a technician that comprises an average of actual travel times within a defined area according to variable travel characteristics. The actual travel time is measured and compared to the planned travel time for an indication of travel efficiency. The planned travel time is added to a planned work time and compared to an actual work and travel total for an indication of overall performance efficiency.

### CROSS REFERENCE TO RELATED APPLICATIONS

The present application claims priority under 35 U.S.C. § 119 to co-pending U.S. Provisional Application No. 60/582,229 entitled “Method and System for Management of Freight Travel Time” filed on Jun. 23, 2004, and which is expressly incorporated herein by reference.

### FIELD OF THE INVENTION

The present invention relates to systems, methods, and computer-readable media for creating more accurate management and scheduling tools. More particularly, the present invention relates to systems, methods and computer-readable media for the creation of travel time standards that more accurately reflect the variables associated with traveling from one job to the next.

### BACKGROUND OF THE INVENTION

Companies are constantly striving to improve the efficiency of their operations. Often, this entails gathering data on various aspects of their operation and analyzing this data for improvement opportunities. The data that is gathered is often used to develop performance metrics that are used as a standard against which future performance will be measured. One common example relates to developing time standards for technicians for each job that they routinely perform. For example, a telecommunications company may determine that installing a new telephone line in a house takes an average of 45 minutes. This standard may be determined from analyzing an historical sample of telephone line installations for which the actual time on the job was tracked.

Many routine job tasks may be assigned a time standard with a high degree of accuracy due to the lack of variables involved. For example, a telephone line installation may consist of steps A, B, C, and D, with little variance from house to house. Using this time standard, and other similar job task time standards, a telecommunications company may attempt to efficiently schedule and distribute work orders amongst the various technicians assigned to a shift. A problem arises when travel time to, from, and between the various jobs is taken into consideration. Travel time can account for approximately 25% of the time that technicians spend during the course of a shift. Unfortunately, travel time includes many variables, including but not limited to road type, road conditions, type of vehicle used, weather, seasons, amount of traffic, time of the day, day of the week, and urban versus rural locations.

There are products on the market, such as MapQuest by MAPQUEST.COM, INC., that will map the distance between points A and B and provide an estimated travel time between those points. However, these products only use the distance and the speed limit to determine the estimated time. A large number of variables, many listed above, exist that may greatly decrease the accuracy of an estimated travel time based solely on a speed limit and distance. With an accurate measure of travel time, coupled with accurate job task time standards, a company is able to more efficiently schedule jobs for its technicians, and may accurately measure and monitor their job performance.

### SUMMARY OF THE INVENTION

Aspects of the present invention address these issues by providing a method for creating a technician performance measure for job-related travel and a method and computer-readable medium for measuring the efficiency of a technician. According to one aspect of the present invention, the segment distance between locations within a defined area is obtained. An average speed measurement from within the defined area is received from a database. The average speed measurement is determined by calculating an average of all speed measurements that are stored within the database that correspond with a travel characteristic stored with the speed measurements. The travel characteristic describes at least one variable travel condition within the defined area. A to-job travel time estimate is calculated by dividing the segment distance measurement by the average speed measurement. An in-job travel time estimate, determined from historical measurements within the defined area, is added to the to-job travel estimate to arrive at a total planned travel time estimate.

According to another aspect of the present invention, the efficiency of a technician is measured. An estimate of the amount of time required for the technician to complete a plurality of tasks is calculated. An estimate of the amount of time required for the technician to travel is calculated using a historical sample of travel times within the defined area where the plurality of tasks will be completed. The task completion time and travel time estimates are added to arrive at a total planned job time estimate. The time to actually complete the tasks is measured, including the actual travel time. The measured actual time to complete the tasks and travel is compared with the total planned job time estimate to determine the efficiency of the technician. The measured actual travel time may also be compared to the planned travel time estimate to determine a travel efficiency figure. A further aspect of the present invention is directed to computer readable media to instruct a computer to measure the efficiency of a technician in the manner summarized above.

These and other features and advantages, which characterize the present invention, will be apparent from a reading of the following detailed description and a review of the associated drawings. It is to be understood that both foregoing general description and the following detailed description are exemplary and explanatory only and are not restrictive of the invention, as claimed.

### BRIEF DESCRIPTION OF THE DRAWINGS

FIG. 1 illustrates a detailed technician summary report according to one embodiment of the present invention.

FIG. 2 illustrates the planned travel time estimation process and actual travel time determination according to one embodiment of the present invention.

FIG. 3 illustrates a contingency travel time estimation chart according to one embodiment of the present invention.

FIG. 4 illustrates the logical operations for determining the total performance efficiency and the travel time efficiency of a technician according to one embodiment of the present invention.

FIG. 5 illustrates the logical operations for determining a planned travel time estimation according to one embodiment of the present invention.

### DETAILED DESCRIPTION OF THE PREFERRED EMBODIMENT

Developing accurate performance measures for employees is an important step for a business to take. By being able to accurately measure the performance of its employees, a company can take measures to increase the efficiency of its employees and corresponding operations. One method for determining how efficiently an employee is managing her time is to compare the time that it takes for the employee to perform each task to a standard that represents the time that it should theoretically take to perform the same task. Similarly, the time that it takes for an employee to drive from job to job can be compared to a standard to determine if it is taking the employee too long to travel between jobs, or if the employee is diligent in her efforts to work efficiently. According to embodiments of the present invention, a method creates standards against which the actual performance of an employee is measured against. Further, the present invention creates travel time estimations that take into account multiple variables that can change the amount of time it takes to drive from point A to point B along the same route.

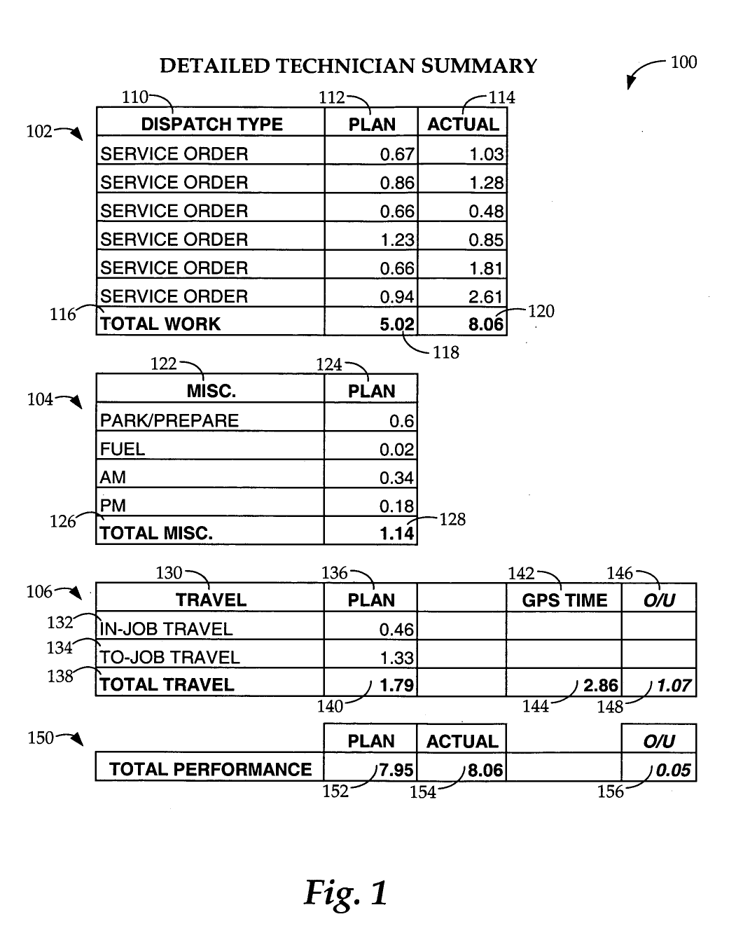

FIG. 1 shows a detailed technician summary report 100 according to one aspect of the present invention. Report 100 details the time spent for a particular technician during a day. According to the embodiment shown in FIG. 1, report 100 is divided into four principle sections, work section 102, miscellaneous section 104, travel section 106, and total performance summary section 150. Work section 102 shows the type of work performed, the theoretical time allotted per task, and the actual time spent on each task. Dispatch column 110 shows the types of work assigned to the technician for that particular day. In the example shown in FIG. 1, the technician is assigned 6 service orders for which she will respond to perform various tasks. Plan column 112 lists the time allotted for each task. The first entry in plan column 112 is 0.67. This means that the first service order should take 0.67 hours to complete. This estimate or “job standard” is preferably the result of numerous historical time samples. Ideally, as routine tasks are performed, the actual time that the technician takes to complete the task is entered into a database. An average of these times may be used as a standard against which technicians are compared and with which work is scheduled. It is to be understood that any number of samples may be used in calculating an average time for a job in creating these job standards. Alternatively, the job standards may be theoretical time estimates created by one or more persons based on knowledge, expertise, experience, or any number or combination of other factors.

Actual column 114 lists the actual times taken to perform each task listed in dispatch column 110. As an example, prior to the beginning of a work shift, the plan columns 112 will be filled out according to the appropriate standards. As the technician performs each task throughout her shift, she keeps track of the time it took to perform each task and records the time corresponding to each task in actual column 114. Alternatively, the time taken to complete each task may be recorded by the technician or other personnel at the end of the shift. In the example shown in FIG. 1, the time entries in actual column 114 include the travel time from one job to another. For example, the first entry in the work section 102 shows that the time that it took for the technician to drive to the job and complete the first task was 1.03 hours. At the completion of the first task, the technician began recording the time again, drove to the second job, and completed the task in 1.28 minutes. This contrasts the plan column 112 for which travel estimations are not included.

Row 116 provides a sum of the individual times listed under the plan and actual columns 112 and 114 respectively. Sum 118, for example, shows that the total time required for the technician to complete her required tasks for that day is estimated at 5.02 hours. Sum 120 shows that it actually took the technician 8.06 hours to complete her work, including the time required to drive between jobs. As will be discussed, planned travel times as well as other miscellaneous planned times will be added to sum 118 before comparing the number to sum 120 which includes work and travel. Miscellaneous section 104 includes estimated times for any variety of miscellaneous factors that the employer may wish to add to the total planned work day for the technician. In the example shown in FIG. 1, miscellaneous column 122 includes items such as “park/prepare” corresponding to time spent parking and preparing for jobs, “fuel” corresponding to time spent fueling the technician's vehicle, and “AM” and “PM” corresponding to additional time spent in the morning and evenings on miscellaneous administration or other necessary tasks.

Similar to the estimated task times listed under plan column 112 of the work section 102, the time estimations listed under plan column 124 corresponding to the miscellaneous tasks listed under column 122 may be based on historical samples, or may simply be theoretical based on other factors. Row 126 provides a sum of the individual times listed under plan column 124. In this example, sum 128 shows that the total time required for the technician to complete the listed miscellaneous tasks for the day is estimated at 1.14 hours. It should be noted that the actual times taken to complete the miscellaneous tasks listed in column 122 are included in the times listed in actual column 114 in the work section 102. As will be discussed, the times listed in the actual column 114 could be limited only to the time taken to complete the corresponding task, with all other miscellaneous and travel times appropriately listed in the miscellaneous and travel sections 104 and 106, respectively.

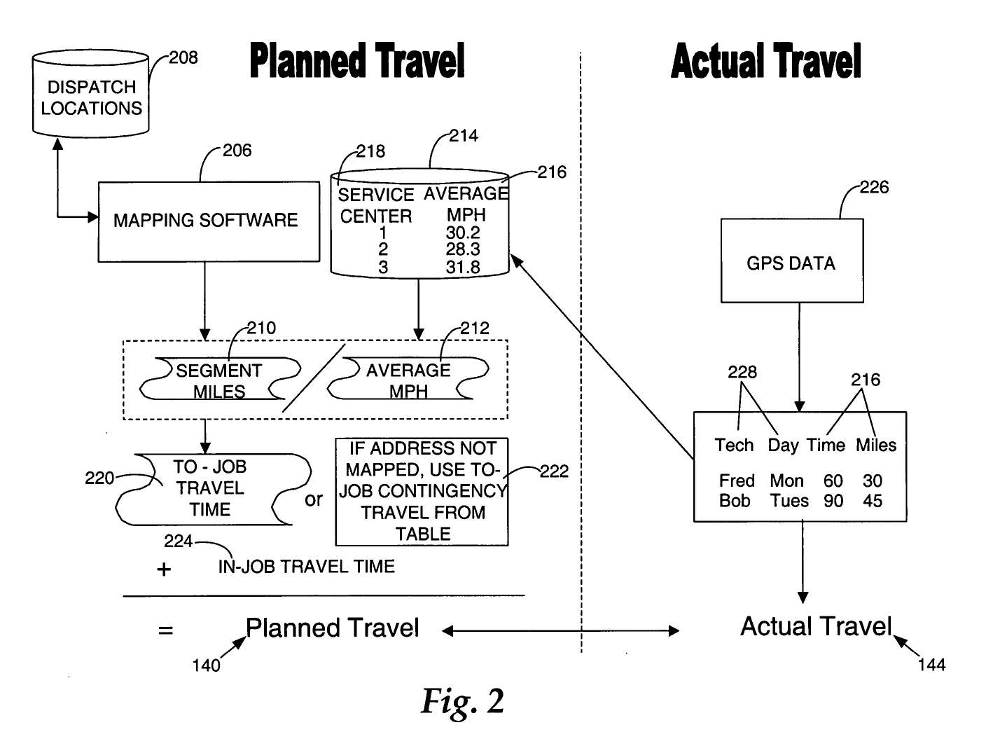

Travel section 106 shows the planned travel time for the technician for the day, the actual travel time, and an efficiency indication based on a comparison of the two times. Travel column 130 includes two travel components, in-job travel 132 and to-job travel 134. In-job travel 132 includes the total time that a technician travels after he has traveled from one service address to another. For example, this type of travel for a telecommunications technician might include driving to and from connection boxes and a commercial or residential building while installing or troubleshooting telephone lines. To-job travel 134 includes the time that a technician spends traveling between jobs. For example, when a technician completes a service order at one address, she will drive to the next address to begin work on the next service order. The estimations for in-job and to-job travel for a technician for a given day are listed in the plan column 136. The manner in which these estimations are determined will be described in detail with respect to FIGS. 2, 3, and 5 below. Row 138 lists the total travel times, including the total planned travel time 140 and the total actual travel time 144.

Column 142 is labeled “GPS Time.” The total actual travel time 144 represents the actual time that the technician's vehicle was in motion during the day, from the time that the vehicle left the service center for the first job, until the vehicle came to a stop back at the service center after all of the jobs were completed. This time is preferably measured using precision instrumentation such as a global positioning system (GPS) mounted within the technician's vehicle. The GPS system can be programmed to record only the time that the vehicle is in motion or stopped for less than a predetermined time, i.e. 90 seconds. By programming the system to continue recording when the vehicle is stopped for less than 90 seconds, the time that the vehicle is stopped at traffic lights and stop signs will be captured. It is to be understood that the actual travel time may be measured not only using a GPS, but also using any means now known or developed in the future. The total actual travel time 144 is compared to the total planned travel time 140 to arrive at an efficiency indicator 148. In the embodiment shown in FIG. 1, the efficiency indicator 148 listed under “O/U” in column 146 indicates whether the total actual travel time 144 is over or under the total planned travel time 140. A positive 1.07 hours indicates that the technician's actual travel time during the day was 1.07 hours more than the total planned travel time.

The total performance summary section 150 shows the plan sum 152 of the planned times 118, 128, and 140 from work section 102, miscellaneous section 104, and travel section 106 respectively. Also listed here is the actual sum 154 carried forward from sum 120 of the work section 102. This sum 154 represents the actual time that the technician spent on the job that particular day. The actual sum 154 spent on the job is compared to the estimated plan sum 152 on the job to arrive at an efficiency indicator 156. In this example, the technician spent 0.05 hours more than was planned for that day. Report 100 allows a manager to look at efficiency indicators 148 and 156 to determine how well the technician is doing as compared to the plan.

It is to be understood that report 100 is not limited to the format and information shown in FIG. 1, nor is all of the information shown required by embodiments of the present invention. For example, report 100 compares the planned and actual total performance sums 152 and 154 to arrive at efficiency indicator 156 and planned and actual travel times 140 and 144 to arrive at efficiency indicator 148. As discussed above, the planned and actual total performance sums 152 and 154 incorporate work and travel times together. It may be preferred that the work and travel times be compared separately. In this situation, the times measured and entered in column 114 would include only the amount of time spent completing the job, without travel time included. An over/under efficiency indicator could then be included to highlight the difference between the planned and actual work times just as shown for the travel section 106. In addition, any number of miscellaneous times could be added or deleted from report 100, and could be incorporated into work and travel sections 102 and 106 rather than being separated and placed in miscellaneous section 104. Further, report 100 and any other reports generated with similar information may be generated manually by an operator, or could be the result of a software application programmed to prompt a user to enter the required fields, calculate the planned times as described below, and generate report 100 for printing or electronic display.

FIG. 2 shows how the planned total travel time 140 and actual total travel time 144 is determined and used. To estimate how much travel time will be required for a technician, the dispatch locations must be known. The addresses associated with the service orders are stored in a database 208. These addresses are retrieved from the database 208 and sent to mapping software 206. Alternatively, the addresses may be manually input into a computer to be used by the mapping software 206. Mapping software 206 determines the segment distances from the starting location to the first job, between jobs, and from the last job back to the starting location. The sum of the distances results in segment miles 210. Segment miles 210 is divided by the average miles per hour (MPH) 212 to arrive at the to-job travel time estimate 220. It is to be understood that while the distance and speed units shown in FIG. 2 are miles and MPH, any distance and speed units are appropriate as long as their use is consistent so that dividing the distance by the speed results in a corresponding time unit.

Rather than using the posted speed limits of the routes mapped by the mapping software 206, one embodiment of the present invention uses historical travel time and distance data to calculate the average MPH 212. Sample MPH measurements 216 are taken while technicians drive during their work shifts. These sample MPH measurements 216 are stored in database 214. The sample MPH measurements 216 may be noted by the driving technician or other personnel riding with the technician, or may preferably be recorded using precision instrumentation such as GPS systems installed in the vehicle driven by the technician which provide GPS data 226. The GPS data 226 may be downloaded into database 214 from each vehicle used in a day at the end of each day in order to create a large sample of sample MPH measurements 216 to create more accurate average MPH 212 calculations, or periodic samples of actual GPS data 226 may be downloaded into database 214.

Travel characteristics 228 corresponding to variables having an effect on traffic are also stored along with the sample MPH measurements 216 in database 214. One such characteristic is location. The sample MPH measurements 216 are associated with at least one defined area. In the example shown in FIG. 2, the sample MPH measurements 216 are associated with service centers 218. Each service center 218 services a particular geographical area. Sample MPH measurements taken during travel within the area assigned to service center 1, for example, are stored with an indication that they were taken within the area assigned to service center 1. Whenever travel is planned in areas serviced by service center 1, the sample MPH measurements 216 corresponding to service center 1 are averaged to arrive at an average MPH 212 for use in determining to-job travel 220. By doing this, variables corresponding to the area assigned to a service center are taken into consideration, a more accurate MPH standard created, and a more accurate to-job travel time estimation is possible.

In other words, it may take an average of 10 minutes to travel a 10 mile stretch of highway with a posted speed limit of 60 MPH within the geographical area assigned to service center 1, while it takes 90 minutes to travel a similar 10 mile stretch of highway with a posted speed limit of 60 MPH within the geographical area assigned to service center 2. By taking an average of only the sample MPH measurements 216 taken within the area defined by the applicable service center 218, a more accurate average MPH 212 will result, improving the to-job travel time estimation 220.

To further improve the accuracy of the average MPH 212 calculation, additional travel characteristics 228 may be stored with the sample MPH measurements 216 in database 214. For example, characteristics 228 such as day of the week, time of the day, season of the year, weather descriptions such as “rain” or “clear,” technician, or any other identifiable variable that could affect travel time in a particular geographical area may be stored with each sample MPH measurement 216. After doing so, a user or software application may search database 214 for sample MPH measurements 216, sorted by characteristic, to arrive at a pool of sample MPH measurements 216 taken under similar conditions as will be experienced by the technician for which travel is planned.

For instance, assume that technician Smith will be driving the next day from point A to point B within the geographical area assigned to service center 1 at approximately 8 am in January. When estimating the to-job travel time 220 for Smith, the average MPH 212 may be taken from a pool of sample MPH measurements 216 that are associated with service center 1. This average MPH 212 will be more accurate than simply using the posted speed limits in that area since, as discussed above, the average will be taken from actual travel times measured from the area. For improved accuracy, the sample pool may be further limited by sorting the sample MPH measurements 216 according to the time 8 am, or a range of time that includes 8 am. The resulting average MPH 212 should give a clearer picture of the amount of time that it will take Smith to travel, as 8 am may be in the middle of rush hour, requiring additional time. For greater accuracy, the pool of sample MPH measurements 216 may be further limited to those taken in January, or even by the sample MPH measurements 216 taken when Smith was driving, or any combination of stored characteristics.

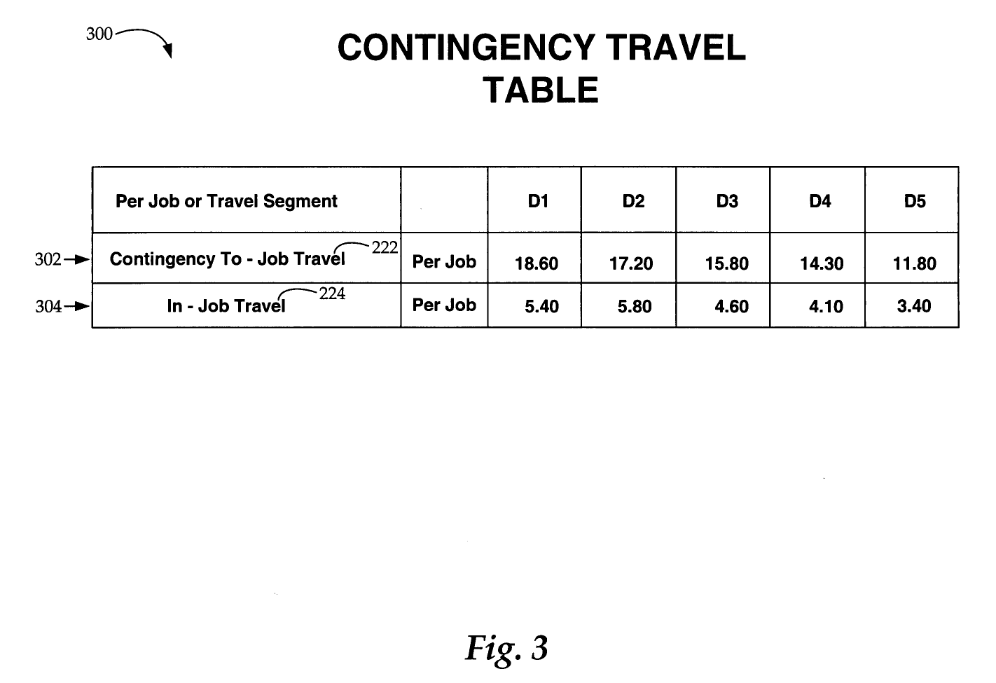

Once the to-job travel time 220 is calculated, it may be entered into row 134 of report 100, shown in FIG. 1. In-job travel time 224 is determined and entered in row 132 of report 100. In-job travel time 224 is added to to-job travel time 220 to arrive at planned travel time 140 and entered in row 138 of report 100. In-job travel time 224 is found in contingency travel table 300 and will be discussed below with reference to FIG. 3. Additionally, if any address is unable to be mapped by mapping software 206 for any reason, the to-job contingency travel time 224 is obtained from contingency table 300 and entered into row 134 of report 100 for calculating planned travel time 140, rather than calculating to-job travel time 220. Planned travel time 140 is compared with actual travel time 144 to determine the efficiency of the technician, as discussed above with respect to FIG. 2.

FIG. 3 shows a contingency travel table 300, which is used to estimate the in-job travel time 224 for each job performed by a technician, as well as to estimate the contingency to-job travel time 222 when a job address cannot be mapped. Table 300 provides sample travel time estimations that differ depending on in which density area the technician will be working. In this example, five density areas are shown, D1-D5. Each geographical area for which a technician might work is categorized according to these density areas. A density area might represent the number of telecommunication lines per square mile. The amount of travel required during a job and between jobs would vary depending on the density area. Alternatively, the density areas might represent urban, suburban, and rural, or any other desired classification. The estimations in a to-job travel row 302 are determined using an average of actual times measured during travel between jobs within each density area D1-D5. As an alternative, the historical output of planned travel times could be recycled into the standards and used. Similar to the determination of to-job travel time estimations in row 302, the estimations in an in-job travel row 304 are determined using an average of actual times measured during travel while completing a job within each density area D1-D5.

The purpose of contingency travel table 300 to arrive at to-job travel estimations is to provide time estimations that are more accurate than using estimated distances and posted speed limits when more precise estimations calculated using the segment miles 210 and average MPH 212 is not available due to imprecise addresses, lack of data in database 214 for a particular characteristic 228, or any other error. The in-job travel times 224 are usually much less than the to-job travel times 220 since shorter distances or no distance is driven while performing a job when compared to the distances driven between jobs. For this reason, there is less error involved and less impact on the total planned travel time 140 if not precisely accurate. Therefore, using time estimations based on density areas is sufficiently reliable and calculating in-job travel times 224 in a manner similar to the to-job travel time calculations described above is not necessary. One skilled in the art will appreciate that the in-job travel times 224 may be similarly calculated using GPS historical measurements and variable travel characteristics similar to the to-job travel time calculations described herein.

As an example, assume a technician's work day will consist of performing job A in D2 and job B in D4 and that the address of job B cannot be mapped by mapping software 206. To calculate planned travel time 140, a user or software application would add 17.20 minutes, which is found at the intersection of to-job travel row 302 and column D2, and 14.30 minutes, which is found at the intersection of to-job travel row 302 and column D4, to arrive at a contingency to-job travel time 222 of 31.50 minutes. The in-job travel time estimation 224 would be 9.90 minutes, calculated by adding 5.80 minutes from the intersection of in-job travel row 304 and column D2 to 4.10 minutes from the intersection of in-job travel row 304 and column D4. The total planned travel time 140 would be the sum of contingency to-job travel time 222 and in-job travel time 224, which is 35.60 minutes.

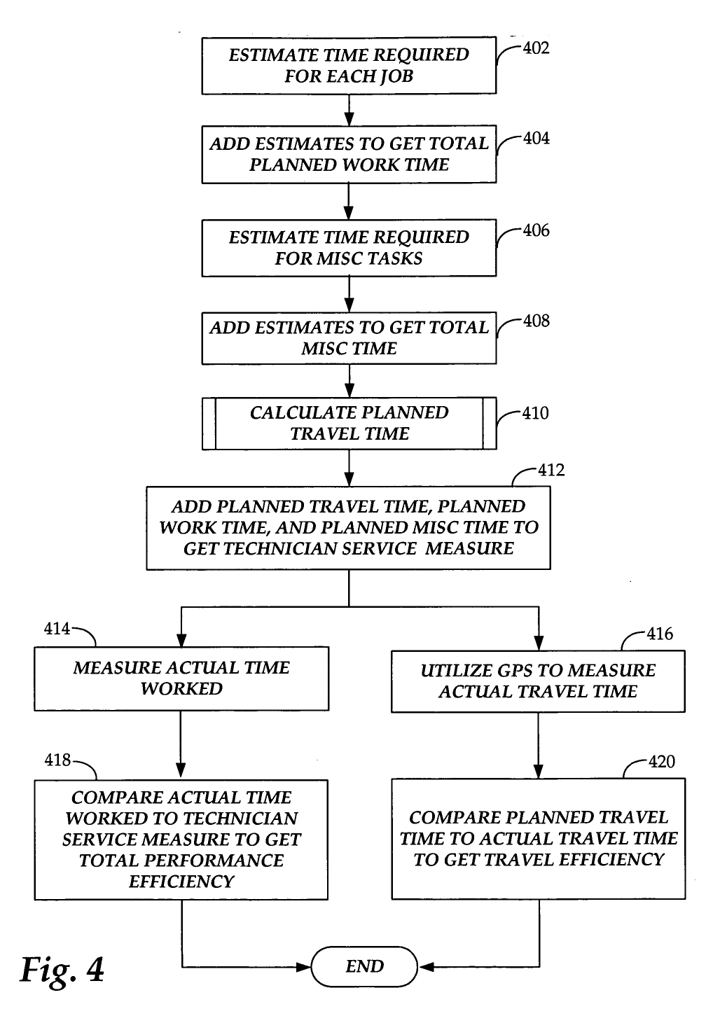

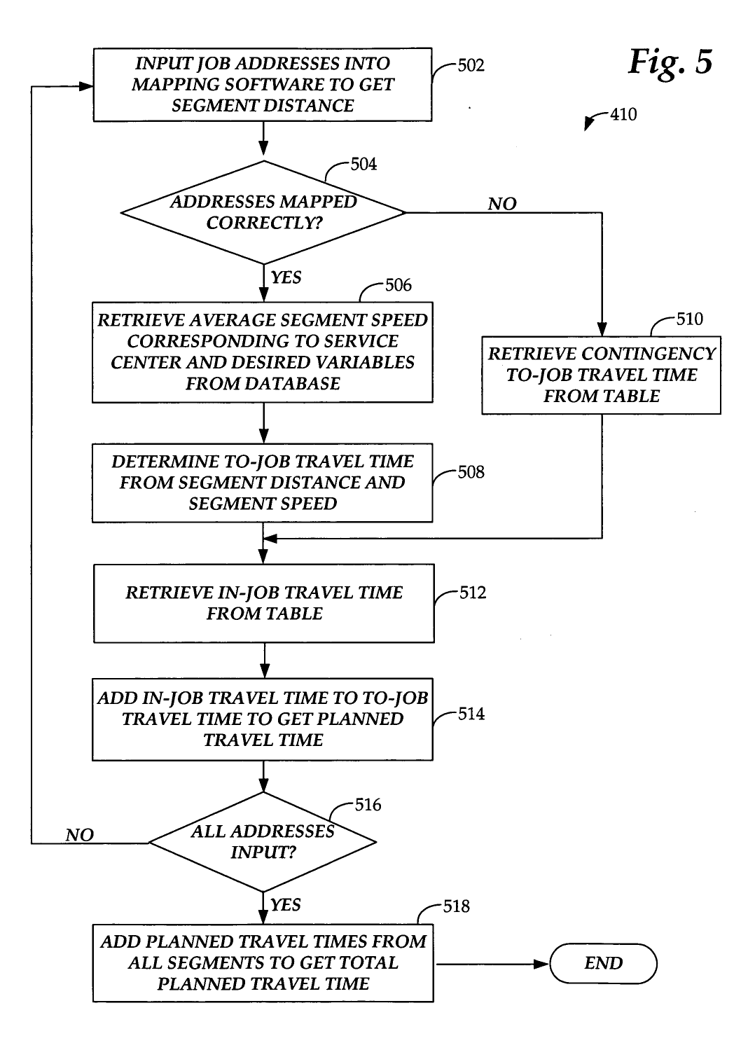

FIG. 4 illustrates a process by which a user or software application may measure a technician's performance efficiency. The process starts at block 402. At block 402, the time required for each job to be performed in a given day or shift is estimated. At block 404, the job time estimates from block 402 are added together to arrive at a total planned work time 118. At block 406, the time required for miscellaneous tasks or allowances is determined. These times are added together to arrive at a total miscellaneous time 128 at block 408. At block 410, the planned travel time for the given day or shift is calculated. Block 410 will be described in detail below with reference to FIG. 5. At block 412, the planned travel time 140 that was determined at block 410 is added to the planned work time 118 calculated at block 404 and the planned miscellaneous time 128 calculated at block 408 to arrive at a total planned work time 152, which may be used as a technician service measure.

The process proceeds to blocks 414 and 416 where the actual time worked 154 and the actual travel time 144 are measured respectively. The actual time worked 154 is the total time that the technician spent on the job, including travel time. The actual travel time 144 is preferably measured using a GPS installed within the vehicle driven by the technician and includes the time that the vehicle is in motion plus time stopped for less than a predetermined amount of time, as discussed above. At block 418, the actual time worked 154 determined at block 414 is compared to the technician service measure determined at block 412 to arrive at an efficiency indicator 156 that is indicative of how efficient the technician was over the course of the day. Similarly, at block 420, the actual travel time 144 determined at block 416 is compared to the planned travel time 140 determined at block 410 to arrive at an efficiency indicator 148 that is indicative of how efficient the technician was in traveling within and between jobs over the course of the day. It should be noted that the procedural blocks shown in FIG. 4 are not limited to the order shown. For example, the planned travel time 140 calculated in block 410 may be performed prior to block 402 or block 406.

FIG. 5 illustrates the procedures taken in block 410 in order to determine a planned travel time 140. At block 502, a user or software application enters the addresses corresponding to each job required for the particular shift or day into mapping software 206 to get the segment miles 210 between jobs. Block 502 may include entering a desired route from one job to the next job. At block 504, a determination is made as to whether the addresses were correctly mapped. If the addresses were mapped correctly, the average MPH 212 corresponding to the applicable service center 218 and any additional variable characteristics 228 is retrieved from database 214 at block 506. At block 508, the segment miles 210 is divided by the average MPH 212 to arrive at the to-job travel time 220.

If the addresses could not be found and could not be manually input by a user at block 504, the process proceeds to block 510. At block 510, the contingency to-job travel time 222 is retrieved from contingency travel table 300 and used as the to-job travel time in place of the to-job travel time 220 determined at block 508. At block 512, the in-job travel time 224 is retrieved from contingency table 300. At block 514, the in-job travel time 224 from block 512 is added to the to-job travel time 220 from block 508, or the contingency to-job travel time 222 retrieved from the contingency table 300 at block 510, to arrive at a planned travel time. At block 516, a determination is made as to whether all addresses have been entered, and therefore if planned travel times have been determined for all travel segments. If not, the process proceeds back to block 502. If all addresses have been input, the planned travel times from all travel segments are added at block 518 to arrive at a total planned travel time 140.

The systems, methods, and computer-readable media according to the present invention enable a company to monitor and maximize technician efficiency, including both work-related and travel-related efficiency. By developing improved performance and travel measures, a technician's work day can be planned more accurately than ever before. The accuracy with which the planning can be accomplished provides an incentive for technicians to adhere to and attempt to surpass the planned performance times. This accuracy also allows for improved scheduling, increasing the efficiency of a company's operations.

The above specification, examples and data provide a complete description of the manufacture and use of the composition of the invention. Since many embodiments of the invention can be made without departing from the spirit and scope of the invention, the invention resides in the claims hereinafter appended.

1. A method for creating a technician performance measure for job-related travel, the method comprising:
receiving a travel segment distance measurement between at least two locations within at least one defined area;
receiving an average speed measurement from a database;
wherein the average speed measurement is determined from calculating an average of all speed measurements of a plurality of speed measurements stored in the database that correspond to a requested travel characteristic within the at least one defined area;
wherein at least one travel characteristic is stored in the database with each of the plurality of speed measurements such that each of the at least one travel characteristic describes at least one variable travel condition within the at least one defined area; and
calculating a to-job travel time estimate by dividing the segment distance measurement by the average speed measurement.

2. The method of claim 1, wherein the at least two locations corresponds to at least two addresses and wherein the segment distance measurement is determined by mapping the at least two addresses and measuring the distance by roadway between the at least two addresses according to a desired route.

3. The method of claim 2, wherein computer-readable media is used to map the at least two addresses and measure the distance by roadway between the addresses according to a desired route.

4. The method of claim 2, wherein if any of the at least two addresses is not located on a map, then calculating the to-job travel time estimate comprises:
receiving at least one estimated to-job travel time from a table comprising travel time estimations per job according to density designations assigned to each of the at least two locations.

5. The method of claim 4, wherein the to-job time estimations are created from historical time data measured while technicians traveled between jobs, and wherein the traffic density designations are classifications with which the historical time data is associated depending on traffic density where the historical time data was collected.

6. The method of claim 1, further comprising adding at least one in-job travel time estimation corresponding to travel that occurs during at least one job to the to-job travel time calculation to arrive at a total planned travel time estimation.

7. The method of claim 6, wherein the at least one in-job travel time estimation is created from historical data measured while at least one technician traveled during a plurality of jobs.

8. The method of claim 1, wherein the plurality of speed measurements stored in the database were created using a Global Positioning System (GPS) installed in a vehicle operated by the technician.

9. The method of claim 1, wherein the at least one defined area comprises an area assigned to a particular service center.

10. The method of claim 1, wherein the at least one travel characteristic comprises a particular technician.

11. The method of claim 1, wherein the at least one travel characteristic comprises a time of day range.

12. A method for measuring the efficiency of a technician, the method comprising:
calculating an estimate of the amount of time required for the technician to complete a plurality of tasks;
calculating an estimate of the amount of time required for the technician to travel, wherein the travel time estimate is specific to a defined area corresponding to the plurality of tasks, and wherein the travel time estimate is based on a historical sample of travel times measured in the defined area;
adding the task completion time estimate and the travel time estimate to arrive at a total job time estimate;
measuring actual time taken to complete the plurality of tasks, wherein the actual time includes travel time;
measuring actual travel time; and
calculating total technician efficiency by comparing the measured actual time to the calculated total job time estimate.

13. The method of claim 12, wherein calculating the estimate of the amount of time required for the technician to complete the plurality of tasks comprises:
for each task of the plurality of tasks, calculating an average time required to perform the task from a plurality of historical measurements of actual times taken to perform the task to arrive at a time estimate for each task; and
adding each time estimate together to arrive at a total time estimate for the technician to perform all tasks of the plurality of tasks.

14. The method of claim 12, wherein calculating an estimate of the amount of time required for the technician to travel comprises:
receiving a travel segment distance measurement between at least two locations within the defined area;
receiving an average speed measurement from a database,
wherein the average speed measurement is determined from calculating an average of all speed measurements of a plurality of speed measurements stored in the database that correspond to a requested travel characteristic within the defined area, and
wherein at least one travel characteristic is stored in the database with each of the plurality of speed measurements such that each of the at least one travel characteristic describes at least one variable travel condition within the at least one defined area; and
calculating a to-job travel time estimate by dividing the segment distance measurement by the average speed measurement.

15. The method of claim 14, further comprising adding an in-job travel time estimate corresponding to travel that occurs during at least one task to the to-job travel time estimate corresponding to travel from one task to another task, wherein the in-job travel time estimate is created from historical data measured while technicians traveled during a plurality of tasks.

16. The method of claim 12, wherein measuring actual travel time comprises using a GPS installed in an automobile driven by the technician to record the time that the vehicle is in motion and the time that the vehicle is not in motion for less than a predetermined amount of time.

17. The method of claim 12, further comprising calculating the travel efficiency of the technician by comparing the measured actual travel time to the estimated amount of time required for the technician to travel.

18. The method of claim 12, further comprising preparing a detailed technician report that displays the estimated and actual times for completing the plurality of tasks, an efficiency indication based on the difference between the estimated and actual times for completing the plurality of tasks, the estimated and actual travel times, and an efficiency indication based on the difference between the estimated and actual travel times.

19. A computer readable medium having stored thereon computer-executable instructions for causing a computer to perform a method of measuring the efficiency of a technician, the method comprising:
calculating an estimate of the amount of time required for the technician to complete a plurality of tasks;
calculating an estimate of the amount of time required for the technician to travel, wherein the travel time estimate is specific to a defined area corresponding to the plurality of tasks, and wherein the travel time estimate is based on a historical sample of travel times measured in the defined area;
adding the task completion time estimate and the travel time estimate to arrive at a total job time estimate;
measuring actual time taken to complete the plurality of tasks, wherein the actual time includes travel time;
measuring actual travel time; and
calculating total technician efficiency by comparing the measured actual time to the calculated total job time estimate.

20. The computer readable medium of claim 19, wherein calculating an estimate of the amount of time required for the technician to travel comprises:
receiving a travel segment distance measurement between at least two locations within the defined area;
receiving an average speed measurement from a database,
wherein the average speed measurement is determined from calculating an average of all speed measurements of a plurality of speed measurements stored in the database that correspond to a requested travel characteristic within the defined area, and
wherein at least one travel characteristic is stored in the database with each of the plurality of speed measurements such that each of the at least one travel characteristic describes at least one variable travel condition within the at least one defined area; and
calculating a to-job travel time estimate by dividing the segment distance measurement by the average speed measurement.
